(19) United States
(12) Patent Application Publication
(10) Pub. No.: US 2017/0147313 A1
(43) Pub. Date: May 25, 2017

(54) SYSTEM AND METHOD FOR VALIDATING CONFIGURATION DATA VALUES ASSOCIATED WITH SOFTWARE APPLICATIONS

(71) Applicant: Xerox Corporation, Norwalk, CT (US)

(72) Inventors: Anthony Casciano, Victor, NY (US); Bernard Heroux, JR., Webster, NY (US)

(21) Appl. No.: 14/946,213

(22) Filed: Nov. 19, 2015

(51) Int. Cl. G06F 9/445; H04L 9/32

(52) U.S. Cl. CPC G06F 8/61; H04L 9/3247

(57) ABSTRACT

Systems and methods are provided for application software system installation in a user device wherein the desired App includes App configuration data to be entered by the intended user through a user interface. An App configuration data validation processor verifies that the user has correctly entered the desired App configuration data. When the user requests an install of the desired App to a particular device, the system digitally signs the App with the validated embedded data in an App configuration file, which digital signature must be validated by the intended device before installation of the App is accepted on the device. After both validation of the configuration data and the digital signature, the user is then permitted to execute the App on the intended device.

### TECHNICAL FIELD

The presently disclosed embodiments are directed to software application security systems particularly useful for embedding and protecting configuration data values, specific to an end user, into a digitally signed package that can be installed on multiple devices.

### BACKGROUND

Software developers create general use applications (“Apps”) for distribution to a wide variety of users. The users of these applications in turn will deploy, or install, these applications on multiple devices. Deployment, or installation, can be done directly on each device or indirectly to each device through a network connected software distribution system. Each user of an application may have specific configuration data that needs to be entered in order for the application to function properly in the user's environment. (i.e., names, a server address, database connection string, digital certificate, data entry constraints, default values, multi-language labels, multi-language help strings, etc.). This is not uncommon. The application would gather this user specific configuration data after it has been deployed, or installed, on each device. If the application is being installed on many devices, perhaps hundreds, the entry of the user specific configuration data becomes time consuming and the information being entered could be incorrect or different from one installation to the next due to a browser error or other system failings. A better solution would allow the user to enter the user specific configuration data values for the application, have the user entered configuration data values embedded into the application, digitally sign the application for security, and then deploy/install the application on multiple devices. The application would not need the user to enter the user specific configuration data at runtime because the configuration data values are embedded and available for use by the application.

In addition, the configuration data must be trustworthy and so must be authenticated and validated at the run time. Merely facilitating the entry of a configuration data in a convenient preloading system would fail to meet such trustworthiness and validation requirements. There is thus a need for a system which can better validate a user entered application configuration data as well as the digital signatures before operation of the corresponding software application.

### BRIEF DESCRIPTION

Application developers will create and upload a variety of operable software applications which are pre-loading then available in a gallery for user acquisition. The developers typically require pre-loading user configuration data to enable a user to operate the App. The subject embodiments enable this requirement by including an optional XML file, called an App Configuration Data Definition File, hereafter referred to as an “ACDDF”, in the App source code. The ACDDF is optional and defines a set of App Configuration data fields that include names, data entry constraints, default values, multi-language labels and multi-language help strings, etc. When the App includes an ACDDF, the present embodiments provide a way for a user to enter the values for the set of App Configuration data fields defined in the ACDDF. The user interface for entering the values is dynamically generated using the data field definitions contained in the ACDDF. In addition, the embodiments will validate the data values entered using the data entry constraints defined in the ACDDF and associate any App Configuration data entered with the logged in user.

When a user initiates the installation process for an App, the embodiments automatically generate the configuration XML file, using the filename specified in the ACDDF, and adds the file to the top-level folder of the weblet source code. The system then digitally signs the App and installs the App on the devices specified by the user. When the App is run on a device, the App reads the configuration XML file and uses the contents during the execution of the App. The digital signature is validated before the execution.

The disclosed embodiments thus allow developers to include an optional file, the ACDDF, in the App source code. The user interface for entering the configuration data values is dynamically generated using the data field definitions contained in the ACDDF. When a user initiates the installation process for an App, the system automatically generates the configuration XML file, using the filename specified in the ACDDF, adds the file to the top-level folder of the weblet source code, and then digitally signs the App and installs the App on the devices specified by the user. When the App is run on a device, the App reads the configuration XML file and uses the contents during the execution of the App.

According to further aspects illustrated herein, there is provided a method for enabling operation of a computer program in a plurality of operating devices. The method includes providing a gallery of software applications to a user for selective installation on the plurality of operating devices, wherein the Apps require application configuration data to be entered in a ConnectKey file for application operability. The ACDDF is included in an application “ConnectKey” file wherein the ACDDF comprises a set of data fields for receiving the application configuration data to be entered by the user. The application configuration data received from the user is validated and stored in response to a selection of one of the plurality of operating devices for executing a one software application from the gallery, and reading the stored application data for enabling execution of the one software application on the selected operating device.

In accordance with other aspects described herein, a security system for protecting software application operability in a selected operating device is presented. The system comprises the ACDDF including predetermined data fields for completion by a user intending use of a software application on the selected operating device. A first validation processor validates user entered application configuration data in the ACDDF. An application configuration file is compiled from the application configuration data file that is embedded in the software application. A digital signature is applied to the application having the embedded application configuration file. A second validation processor validates the digital signature in response to a user installation request of the software application on the selected operating device.

### BRIEF DESCRIPTION OF THE DRAWINGS

FIG. 1 is a functional block diagram of a computer implemented system comprising a disclosed embodiment; and

FIG. 2 is a block diagram/flow chart detailing steps of an embodiment.

### DETAILED DESCRIPTION

The present description and accompanying FIGURES illustrate the embodiments for a more efficient, secure and trustworthy method and system to allow end users of a software application to embed required configuration data values, specific to the end user, into a digitally signed package that can be installed on multiple devices. Such a method and system enables efficiencies in operation of the software application because the present embodiments do not require the user to enter the user specific configuration data at run time. The configuration data values are thus embedded and available in advance for use by the application, after being validated at the time of data entry, with other embedding in the relevant App configuration file.

Such a system provides internalized protocol to developers to generate the list of data fields with data types, value constraints, language-specific labels, and language specific help text, etc. Configuration data description is thus interpreted by the software application distribution system to automatically generate a user interface for a user to enter and validate the data values required by the App selected by the user. The subject method of saving the “configuration data” user basis is advantageous because it allows the user to configure the same App, in a software distribution system, differently from other users accessing the software distribution system. This is particularly advantageous because even though the configuration of Apps is something that Apps normally do, this is usually done through content that is external to the App (i.e., external file, registry, database, etc.). The method of the subject embodiments employed for adding the configuration data is particularly advantageous because the data is embedded directly into the App so that it cannot be modified.

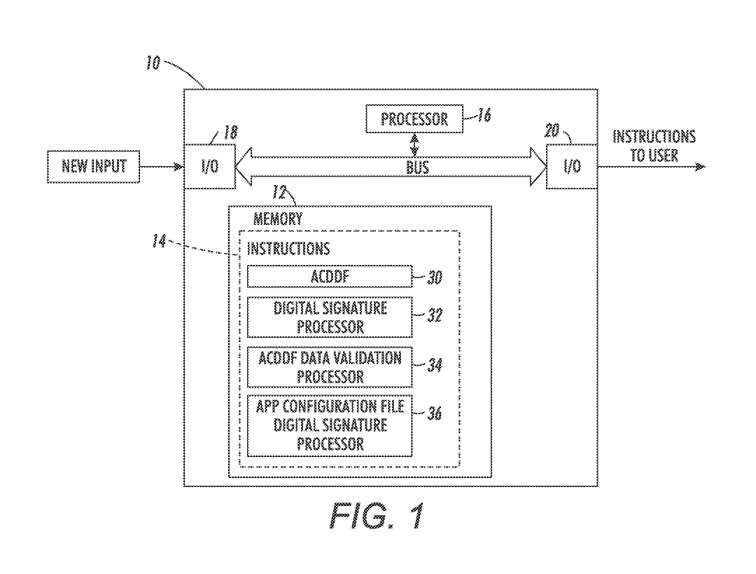

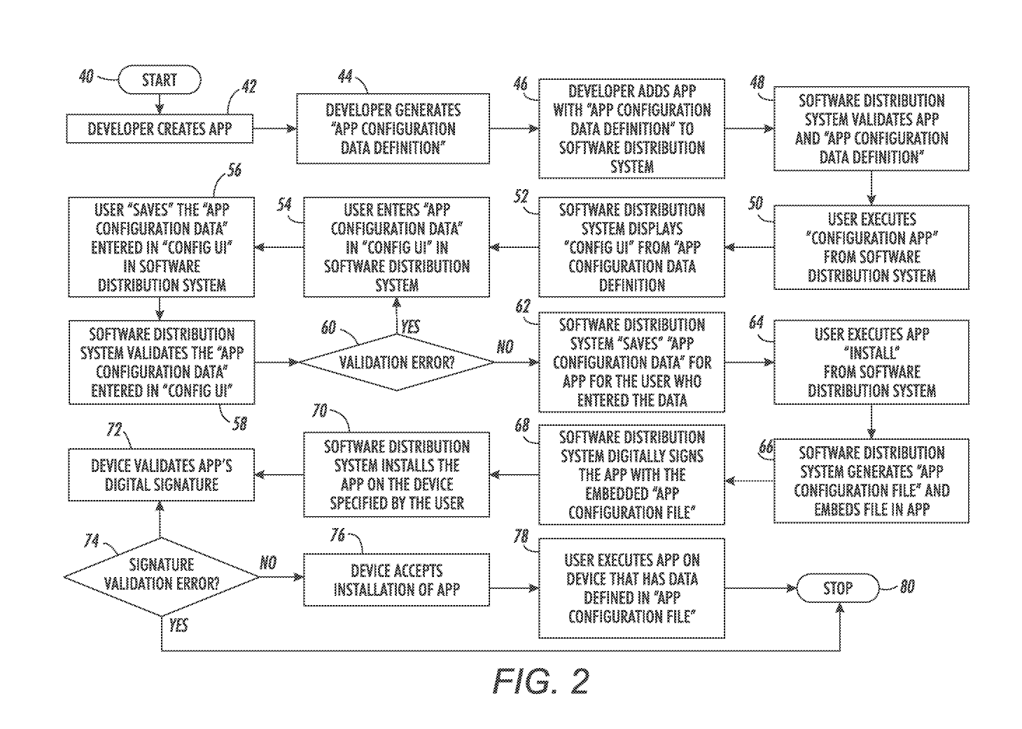

Although the subject embodiments are described in greater detail with reference to FIGS. 1 and 2, this subject method can be segregated into essentially five steps:

First, a developer defines the “App Configuration Data Requirements” in a supplemental source file.

Second, the developer submits for user acquisition, the application, along with the supplemental source file, to a software application distribution system.

Third, the software distribution system interprets the App Configuration Data Requirements and provides a mechanism to allow the user of the software distribution system to enter user specific “App Configuration Data” values.

Fourth, the distribution system validates the App Configuration Data Requirements entered by the user, and then embeds the App Configuration Data with the validated values into the App.

Fifth, the software distribution system produces a digitally signed “App Package” that can be installed on a device indicated by the user. The digitally signed App Package is also validated before installation on the device.

With reference to FIG. 1, a functional block diagram of computer implemented system 10 for validating embedded configuration data values, specific to an end user, into an additionally validated and signed package that can be installed on multiple devices is shown. The illustrated computer system 10 includes memory 12 which stores instructions 14 for performing the method illustrated in FIG. 2 in a processor 16 in communication with a memory for executing the instructions. The system 10 also includes one or more input/output (I/O) devices such as a network interface 18 and a user input/output (I/O) interface 20. The I/O interface 20 may communicate with one or more display(s) (not shown) for displaying information to users, and a user input device such as a keyboard or touch or writable screen, and/or a cursor control device, such as a mouse, trackball, or the like, for inputting text and for communicating user input information and command selections to the processor device 16. The various hardware components 12, 16, 18, 20 of the system 10 may all be connected by a data/control bus 28, such as a PC, a desktop, a laptop, palmtop computer, portable digital assistant (PDA), server computer, cellular telephone, tablet computer, pager, combinations thereof, or other computing device capable of executing instructions for performing the exemplary methods of the embodiments.

The memory 12 may represent any type of non-transitory computer-readable medium such as random access memory (RAM), read-only memory (ROM), magnetic disk or tape, optical disk, flash memory, or holographic memory. In one embodiment, the memory 12 comprises a combination of random access memory and read-only memory. In some embodiments, the processor 16 and memory 12 may be combined in a single chip. Memory 12 stores instructions for performing the exemplary method as well the processed data.

The network interface 18 allows the computer to communicate with other devices via computer network, such as a local area network (LAN) or wide area network (WAN), or the Internet, and may comprise a modulator/demodulator (MODEM), a router, a cable, and/or Ethernet port.

The processor device can be variously embodied, such as by a single core processor, a dual core processor (or more generally by a multiple core processor), a digital processor and cooperating math co-processor, a digital controller, or the like. The digital processor 16, in addition to executing instructions 14, may also control the operation of a computer running a software application selected by a user and implemented in accordance with the subject embodiments.

The instructions 14 are especially illustrated to include four items: an App Configuration Data Definition File (ACDDF) 30, a digital signature processor 32, an ACDDF validation processor 34, and an App configuration file digital signature processor 36. Although these elements are shown as software items in the memory instructions, they could alternately be implemented structurally as hardware/firmware in a manner similar to processor 16.

The term “software”, as used herein, is intended to encompass any collection or set of instructions executable by a computer or other digital system so as to configure the computer or other digital system to perform the task that is the intent of the software. Software as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program produce may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive or independent disks (RAID), or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method for populating a form. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

With reference to FIG. 2, the method steps of an embodiment are more particularly illustrated. A developer will create an App 42. For purposes of exemplification, the App could be one for allowing members of a sale force of a company to enter travel expenses. The developer generates 44 the App Configuration Data Definition required for a user to enable operation of the App. The App Configuration Data may include many things such as are detailed above. The developer then adds the App with the App Configuration Data Definition requirements to a software distribution system such as a studio or gallery accessible by intended users for intended acquisition and then operation. The software distribution system validates the App and the App Configuration Data Definitions to verify that the specified data definitions will properly enable App operation by the user. The user then executes 50 a Configuration App step to acquire the App from the software distribution system so that the acquisition process by the user can begin. The software distribution system displays 52 a Configure UI (user interface) from the App Configuration Data Definition file to present a user interface to the acquiring user to facilitate the entry of the desired configuration data. The user enters 54 the desired configuration data in the user interface. The configuration data is saved 56. For enhanced security and trustworthiness, the software distribution system then validates 58 that the proper configuration data has been correctly entered. If a validation error occurs 60, then the system will prompt the user to re-enter the configuration data 54. If there is no validation error, then the system will save 62 the App Configuration Data for the App for the user who entered the data. When the user wants to operate the acquired App, the user will execute an App “install” from the software distribution system. The software distribution system generates an App Configuration File and embeds 66 the file in the selected App. A digital signature 68 is applied to the App with the embedded App Configuration File for enhanced security and trustworthiness of the installed file. The system installs the App onto the device specified by the user including the digital signature 70. The specified device validates the App's digital signature 72. If there is a signature validation error 74, then operation of the App on the device is stopped 80. If there is no validation error, the device accepts the installation of the App 76 and the user is free to execute the App 78 on the device that has the data properly defined in the App Configuration File.

It is noteworthy that the software distribution system validates the App Configuration Data entered by the intended user through the user interface before the user executes an install instruction, and then again the digital signature applied by the system is checked for validation before an operating device accepts installation of the App.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for enabling operation of a computer program in a plurality of operating devices, including:
providing a gallery of software applications (Apps) to a user for selective installation on the plurality of operating devices, wherein the Apps require App Configuration Data to be entered in a Connect Key File for application operability;
including an App Configuration Data Definition File (ACDDF) in the App Connect Key file wherein the ACDDF comprises a set of data fields for the receiving App Configuration Data to be entered by the user;
validating and storing App Configuration Data received from the user in response to a selection of one of the plurality of operating devices for executing a one App of the gallery, and reading the stored App Configuration Data for enabling execution of the one App on the selected o˜erating device.

2. The method of claim 2, further including generating an App Configuration File from the ACDDR in response to an install request from the user for the one App in the one operating device.

3. The method of claim 2 further including embedding the App Configuration File in the one App.

4. The method of claim 3 further including applying a digital signature to the embedded App Configuration File.

5. The method of claim 4 further including validating the digital signature of the one operating device prior to accepting installation of the one App in the one operating device.

6. The method of claim 5 further including installing and operating the App in the one operating device.

7. A security system for protecting App operability in a selected operating device comprising:
an App Configuration Data Definition File (ACDDF) including predetermined data fields for completion by a user intending use of an App on the selected operating device;
a first validation processor for validating user entered app configuration data in the ACDDF;
an App Configuration File compiled from the validated app configuration data file and embedded in the App;
a digital signature applied to the App having the embedded App Configuration File; and
a second validation processor for validating the digital signature in response to a user installation request of the App on the selected operating device.

8. The system of claim 7 including a configuration user interface for dynamically presenting selection data field corresponding to the ACDDF associated with a particular app.

9. An application software system including embedded error validation operability comprising:
an application studio having a gallery of software applications (apps) for selecting installation on a plurality of operating devices wherein the apps require App Configuration Data to be entered in a user interface file for application operability.
an App Configuration Data Definition File (ACDDF) included in the user interface comprises a predetermined set of data fields for receiving app configuration data to be entered by a user of the Apps;
an App configuration data validation processor for verifying correct user entry of the app configuration data;
a validated one of the apps including the validated app configuration data embedded in the one App;
a digital signature applied to the validated one of the Apps; and
a digital signature validated one of the Apps validated in response to an install request by the user of the App on an operating device.

10. The system of claim 9 further including a configuration user interface for presenting selective data fields corresponding to the ACDDF.
